(19) United States
(12) Patent Application Publication
(10) Pub. No.: US 2015/0178791 A1
(43) Pub. Date: Jun. 25, 2015

(54) DUAL USE ADVERTISING EXCHANGE

(71) Applicants: John Heffernan, Setauket, NY (US); Neil P. Heffernan, Setauket, NY (US)

(72) Inventors: John Heffernan, Setauket, NY (US); Neil P. Heffernan, Setauket, NY (US)

(21) Appl. No.: 14/578,469

(22) Filed: Dec. 21, 2014

Related U.S. Application Data
(60) Provisional application No. 61/920,259, filed on Dec. 23, 2013.

(51) Int. Cl. G06Q 30/02

(52) U.S. Cl. CPC G06Q 30/0275

(57) ABSTRACT

A visual commercial advertising brokerage coordinates information about available advertising venues submitted by providers of tangible visual advertising display space. The venues may be unused space on tangible traditional structures or substrates, such as municipal signs and structures, on commercial packaging containers, on disposable personal use substrates or other available advertising display spaces. The advertising exchange transmits this data to potential advertisers seeking advertising display space opportunities to advertise goods or services. The data is matched and outputted and archived with cumulative display space requests so that the potential advertisers can access the available visual advertising display space.

### FIELD OF THE INVENTION

The present invention relates to an advertising exchange for incorporating dual product, piggy-back, leap frog and hitchhiking advertising on unadorned surfaces of existing products or structures.

### OBJECTS OF THE INVENTION

The objects of the present invention include the following:
establishment of advertising exchanges, advertisers/buyers and advertisers/sellers.
new revenue producing for dual product manufacturers;
new advertising and marketing medium;
creation of brokerage agencies for dual use advertising;
creation of employment, graphic arts profession;
creation of employment in the printing industries;
enables new companies to manage the advertising application, and install and remove advertising as required; and,
generates revenue for the U.S. Postal Service® and private shipping businesses.

### SUMMARY OF THE INVENTION

In keeping with these objects and others which may become apparent, the present invention involves introducing advertising exchange to facilitate buy and selling of advertising in this new medium. The use referred to is dual product advertising, including the printing of commercial advertising on any or every suitable unadorned surface. For example, if one surface of an object, such as a tote carry bag, is adorned on a front side thereof with a primary advertising logo of a merchandising establishment associated with products to be carried in the tote bag, the unadorned reverse side of the tote bag may be adorned with secondary third party advertising, whether associated or not with the primary advertising logo on the prominent front surface of the tote bag.

For the purpose of clarity, the term “secondary advertising” refers to the added advertising being added to unadorned surfaces of a product, whether or not the product is adorned with a primary advertising logo thereon. “Primary” advertising refers to pre-existing advertising, if any, adorned on at least one viewing surface of a product, Even if a product does not have a primary advertising logo, such as the surface of a road construction structure, the added advertising is referred to as “secondary” advertising, to distinguish from any “primary” advertising which may exist on a product or structure's surface.

The idea of this patent application is to develop and establish dual use of single purpose products, often disposal products, items, objects and structures suitable for secondary commercial advertising, without distracting, distorting, changing, interfering with the original use, intended use, purpose or established use of the product whether or not the product is adorned with a primary advertising logo on one or more surfaces of the product.

Open spaces are everywhere. These include previously unadorned surfaces suitable for printing, posting, painting, displaying commercial advertising, for example, the unadorned surfaces of boxes and cartons, such as, for example, at least one of all inside surfaces, outside and inside of paper bags, corrugated boxes not already adorned with a primary advertising logo.

Providing that the open space is printable, this secondary space can be used for commercial advertising. This patent is to utilize this unadorned secondary space for such use, through establishing dual use for a product and introducing a new advertising medium for secondary use on a product, whether or not the product is adorned on a primary surface with an advertising logo.

This patent application turns suitable items and associated material, i.e. packaging, into an advertising medium. This is accomplishing within the normal operation of producing the product. In most cases, no additional equipment needed.

The present invention may be referred to as dual product advertising, piggy-back advertising, leap frog, hitchhiker advertising, open space/open surface advertising, or dual purpose, multi advertising.

The printing of secondary advertising provides a secondary use for such a product, without distorting, interfering or destroying the original or primary use of the product or its associated materials, including any primary advertising already on the product, such as pertaining to an establishment or organization associated with the product. Thus, providing a single use item having a primary purpose and/or with a primary advertising logo, with a secondary use associated with display of a secondary advertising on previously unadorned surfaces of the product, making that product a dual use product.

The present invention utilizes any product and/or its associated material that has a printable secondary surface for the purpose of printing or/and posting of secondary commercial advertising, in addition to primary advertising logos already of the product. It also applies to products without any primary advertising thereon. For the purpose of clarity, the term “secondary advertising” refers to the added advertising added to unadorned surfaces of a product, whether or not the product is adorned with a primary advertising logo thereon. Thus, creating a secondary use for the unused surfaces. One or more of the unadorned surfaces would be used for this secondary advertising. The extent and feasibility of the secondary advertisement would depend on extent and content of the advertised, the type, size shape, form and location the open space or surface takes.

The present invention is very broad and wide in application, which has the potential to generate revenue, increase sales, renew interest in product, generate growth in the economy, and revise interest in the ecology, saving resources and good for the environment.

Any product, item, object suitable for printing or posting advertising form comes within the scope of the present invention and is, by reference, included.

The present invention introduces a new advertising medium that will revitalize the advertising and marketing industry, create new advertising opportunities, and enhance the advertising industry and those advertisers who prefer to advertise in a low key manner.

This patent has the potential to generate revenue, increase sale and renew interest in those dual use products. The application has broad economical outcomes, will require the establishment of new categories of advertising broker agencies, advertising exchanges to buy and sell dual purpose produce advertisement, resulting in increased business and employment in the advertising field.

The present invention is important to the ecology, reducing the waste stream, eliminate the necessary for separate advertising material for those who choose to advertise in this manner.

The manufacture of dual product adverting increases revenues from the advertiser using their product item or object for dual purpose advertising of secondary references thereon.

The leasers of open surfaces benefit from the addition of secondary advertising on objects suitable for printing or posting commercial advertising suitable for printed or posted commercial advertising.

There are many products, items and objects suitable for dual status of commercial advertising, disposal products, non-disposal products, single purpose products, established items, standard use items, services and objects.

For example, the present invention is applicable in, but not limited to, the following areas, products, items, objects, services and sections.

Advertising Exchanges:

The patent establishes a new medium for commercial advertising, generating new revenue for the private sector and the public sector. The operation of this new advertising medium requires the establishment of advertising exchanges to facilitate the buying and selling of advertising.

The advertiser is independent and different from the established use of the original product. The Commercial advertisements printing images (Indicia) may represent commercial institutions, businesses, companies, products, sports, franchises, for profit and not for profit institutions, states, counties, municipals, national, international and local interests that have an interest in promoting indirect advertising.

Individual companies, not necessarily connected or associated with the manufacture of the host dual product, can advertise in this new medium, provided there is agreement between the parties. The advertisements need not necessary be associated; this the source of the original product. They can be independent business or companies requiring to advertise in this new medium.

Commercial details are also applicable to the dual use advertising exchange.

The present invention not only applies to single items or companies but cross marketing and/or cross advertising of items, objects, company, company products from different and independent companies. The emphasis is to focus on all but specialize in dual and multiple advertising, provided the individual companies do not have any objection and agree to the images.

The benefits to the Private Sector are in creating new advertising brokerages to buy and sell advertising for the manufacturers of the tangible dual products, thereby providing an additional revenue stream and adding value to their products.

The benefits to the Public Sector include the fact that revenue would be created by leasing or selling advertising space on tangible public owned product, items, objects and structures.

For Government Authorities, such as the U.S. Postal Service®, besides printing commercial advertising on postage stamps, the U.S.P.S. can provide franking of commercial advertising on letters, parcels as the postage is canceled. Commercial advertising can also be provided on road side mail collection boxes and mail vans and trucks.

For delivery services such as UPS®, FEDEX®, DHL® or other courier services, advertising can be provided on tangible letters, envelopes, packages, parcels, with print/post advertising on suitable surfaces.

With respect to Highway/Road Authorities tangible display surfaces can provide a display space for print or post advertising that can be provided on the parfait (side) of bridges, overpasses and underpasses. Print advertising can also be provided on metal road barriers, permanent and mobile road traffic lane barriers, cones, barrels, road repair signs. Print advertising on municipal water towers can be seen for miles and print advertising can be provided between the bicycle lane lines. Printing of advertising can be provided on wedge road divergence sectioned diagonal lines, tree and column advertising bands, highway and expressway noise barrier walls.

Advertising on tangible display surfaces of municipal authorities can produce revenue for the controlling authority by leasing the sign advertising space.

In the transportation industry, advertising can be provided on tangible surfaces of containers, transported by sea, rail or road. The lease of tangible container sides can generate revenue for the transportation company.

With respect to public service utilities, the painting/posting of advertising can be provided on utility poles, utility transformers, ground-mounted transformers, communications street panels and water authority water towers.

The benefits to the Private Sector, can be providing advertising on product assembly instructions, operational instructions and on gift wrap, where printing of commercial advertising can be provided on the underside of the gift wrap design, and also on unused rear surfaces of greeting cards, thank you cards, personal note cards, disposable paper cups, disposable paper hats, disposable paper protective coats, disposable work uniform overalls and shirts, face masks, the underside of paper plates and on disposable plastic drinking glasses.

Other disposable utensils and items which can provide a tangible display for advertising include plastic knives, forks, spoons, paper napkins, paper towels, craft paper towels and wrapping paper, fast food containers, tray, polystyrene, paper board, drink trays etc. as well as the rear side of adhesive posted notes (i.e. Post-Its®), liners on fiberglass insulation, Rolodex® phone cards. Other tangible substrates which can provide advertising display surfaces include sandpaper, Emery® cloth, vacuum bags, beverage filters, such as coffee filters, industrial filters, paper tubes for sending or holding wrapped substrates, Squeegee® pads, paper drums, party items, hats streamers, buntings, paper cones, tubes, drums, containers, adhesive tape, painter's marking tape, duct tape, electrical tape, Teflon® tape, Spackle® tape, nylon tape, wrapping tape, masking tape, marking tape, all sorts, types, styles and uses of tape, including reflective tape, caution tape, police barrier tape caution warning tape, accident and crime area tape. spackle corner angle tape, Sheetrock® construction board sheets, medical examination bench towel rolls, disposable medical absorbent medical collection/spill/waste towel border/edge print substrates, Band aids®, plasters. Medical plaster rolls. Medical instructions inserted in medical cartons, boxes, bottles and jars, examination latex gloves, (with advertising on the cuffs), as well as on the cuffs of other gloves, such as work, disposal, latex, industrial use gloves, brush heads, supply sacks, burlap sacks, book jackets, inside front and back book covers, empty book pages, calendars, event tickets, raffles, bingo, admission tickets books of chance, hotel door handle tags, do not disturb tags, hotel registration documentation, product assembly sheets, product operational instruction sheets, protection sheets provided on products of glass, windows, furniture, bicycles, kitchen, home appliances.

Tangible display places can be provided on or in cook books, children's games, toys, the bottom of food cans, bottles and tube packaging for food, as well as on packaging /wrapping, boxes, cartons, cases, corrugated containers, and the inside of cartons/boxes, such as the lid, the major and minor flaps and the bottom of the carton. This would include corrugate boxes and cases. Advertising can also be provided on product protection liners, i.e. windows, glass, paintings, works of art, many industrial and commercial, personal items; products that have to be protected from marks, scratches, fingerprints, etc., as well as on new car's protection liners to prevent public exposure before the release date, retail store carry home bags and boxes. Cake boxes, doggie bags from restaurants, lunch bags, private label snacks for chips and popcorn, cookies containers are some of the suitable areas. Private label personal products, soap, creams and lotions. The list is virtually endless, almost anything one can think of may display commercial advertising. The issue is in recognizing and harnessing this potential. This patent accomplishes just this. The printing of decorative images on product surfaces is a standard feature of many industries. Company logo colors, icons, etc. The advertising will not interfere with any of the established product printing, but would be an addition to such printing and generally not on the same surface, but on the reverse or alternate side that is usually unprinted. Giving the existing of printing facilities incorporated in the manufacture processes and associated packaging materials, the present invention is to introduce the printing of commercial advertising and marketing features. The advertising can consist of anything that can be printed on the surface not prohibited by law. The present invention is very specific on detail, method and is not limited to any specific materials

In the art industry, advertisers may wish to collaborate with the dual product manufacture in promoting unknown artists, painters, music writers, songwriters, short story writers, comic strip writers, cartoonists, which may initiate a new interest in this method of self-advertising or promotional exercise for the participating industry.

As mentioned previously, the present invention is applicable to the tissue converting industry printing decorative on paper towels. Incorporated in the present invention is the printing of comic strips, and the introduction of comic strip and cartoons by known and budding writers.

The idea of utilizing these aspects also has dual uses:

1) As a promotional advertisement for secondary advertising sponsored by third parties.

2) As a self-promotional advertisement for the manufacturers of the product's industry.

This present invention turns product packaging and wrapping into an advertising medium, like newspapers and magazines, whose primary purpose is the print news and articles. Each surface may contain single, dual or multiple advertising indicia. The lay out of the advertising copy may take many forms, with repeatable reinforcement typically related to the circumstance of the printing cylinder.

The benefits of the present invention are that it introduces a new advertisement medium for the marketing and advertisement industries, generating new business opportunities and revenues for the industry.

The present invention develops new sources of revenues for the manufacturers of the dual product industries.

The present invention introduces new methods for businesses and others who wish to advertise in this manner.

The present invention reduces the additional materials that would have been used for advertising, by the use of dual products.

The present invention promotes increased use of graphic design, and establishes new business, revenue.

The present invention creates employment in the secondary advertising field. It reduces the waste stream, is good for the environment and reduces pollution by utilizing existing products.

### Private Sector

Revenue for the private sector comes from businesses wishing to advertise in this new advertising medium. The advertisements would be bought and sold through advertisement exchanges operated by advertising agencies, companies and brokers.

The present invention is wide and verified in its application. Examples of such open spaces, piggyback, leap frog, Hitchhiker and dual products advertising potential are as follows:

Packaging: The cartons and boxes that contain products have suitable unused panels that secondary commercial advertising can be placed thereon; including at least some outside panels and most inside panels.

Wrapping material: Both sides of wrapping material can carry secondary commercial advertising.

Retail shopping. Secondary advertising can be adorned on take home carry bags and boxes. These can carry secondary commercial advertising, both outside and inside.

The computerized advertising exchange provides a method for facilitating visual commercial advertising brokerage which includes the steps of

a. using a computer having digital data processing means, digital data storage means, digital data input means, digital data output means and digital data display means;

b. inputting into the computer digital storage means digital data regarding advertising venues, the digital venue data submitted by providers of visual advertising display space comprising availability, respectively, of a plurality of advertising venues which further comprise visual advertising display space opportunities;

c. inputting into the computer digital storage means digital data comprising a plurality of bid requests for the advertising venues comprising available visual commercial advertising space submitted by bid requestors who are potential advertisers seeking to engage at least one of the venues advertising display space opportunities to advertise goods or services;

d. concurrently withdrawing the digital data from the digital computer storage means and feeding it to the computer digital processing means;

e. digitally matching within the computer digital processing means the input digital data comprising the plurality of available-venue visual advertising display space opportunities with the plurality of bid requests for the venues comprising visual commercial advertising space;

f. digitally outputting the result of the matching of digital venue visual commercial advertising display space availability data with the commercial advertising visual display space bid request digital data so as to comprise a digitally-displayable and digitally storable resulting body of digital data comprising
(a) a plurality of commercial advertising visual display space bid requests for formatting and appropriate graphic display presentation to the providers of visual advertising display space as well as;
(b) a plurality of commercial advertising venue visual display space availabilities for formatting and appropriate graphic display presentation to the potential advertiser bid requestors who have submitted the bid requests for the available visual commercial advertising space.

The method of computer advertising brokerage further optionally includes that the computer includes at least one discrete digital data storage means for inputting and storing digital data relating to advertising buyers who are or who may become bid requestors for
(a) entire advertising campaigns;
(b) graphic design services;
(c) physical advertising copy providers;
(d) venue placement providers;
(e) combined providers of physical advertising copy and venue placement;

b. wherein further, the computer includes at least one discrete digital data storage means for inputting and storing digital data relating to advertising venues, further comprising digital information regarding the advertising venues' respective
(a) advertising types;
(b) advertising copy size;
(c) advertising product compatibility

c. wherein further, the computer includes at least one discrete digital data storage means for inputting and storing digital data relating to calculation of costs for the plurality of respective advertising venues;

d. wherein further, the computer includes at least one discrete digital data storage means for inputting and storing digital data relating to views per venue;

e. wherein further, the computer includes at least one discrete digital data storage means for inputting and storing digital data relating to advertising agency contact information;

f. wherein further, the computer includes at least one discrete digital data storage means for inputting and storing digital data relating to talent provider contact information;

g. wherein further, the computer includes at least one discrete digital data storage means for inputting and storing digital data relating to graphic designer contact information;

h. wherein further, the computer includes at least one discrete digital data storage means for inputting and storing digital data relating to advertising placement agent contact information;

i. wherein further, the computer includes at least one discrete digital data storage means for inputting and storing digital data relating to advertising venue owner contact information; and

j. wherein further, the computer includes at least one discrete digital data storage means for inputting and storing digital data relating to advertising venue producers; and further wherein

k. the computer includes at least one discrete digital data processing means comprising at least one proprietary algorithm for accepting and processing and outputting a digital data result product that includes a brokerage exchange displayable and communicable data product that results from manipulation by the at least one algorithm of the digital data from at least one of the stored data types comprising
(a) the entire advertising campaign bid requests;
(b) the graphic design bid requests;
(c) the physical advertising copy bid requests;
(d) the advertising venue placement bid requests;
(e) the combined physical advertising copy bid requests and the advertising venue placement bid requests;
(f) the digital data relating to advertising venues, further comprising digital information regarding the advertising venues' respective advertising types; the advertising venues' respective advertising copy size; the advertising venues' respective advertising product compatibility;
(g) data relating to calculation of costs for the plurality of respective advertising venues;
(h) data relating to calculation of views per venue
(i) data relating to talent supplier contact information;
(j) data relating to advertising agency contact information;
(k) data relating to graphic designer contact information;
(l) data relating to advertising placement agent contact information;
(m) data relating to advertising venue owner contact information; and
(n) data relating to advertising venue producer contact information;

The method of computer advertising brokerage further optionally includes the step that the algorithm is at least one proprietary algorithm. The resultant digital data result product further includes the step of providing at least one offer to at least one bid requestor for the purchase of advertising space. The proprietary algorithm preferably incorporates a series of data manipulations including an auction-style bidding scheme capable of awarding offers to advertising bid requestors in order of largest to smallest bid

In summary, the advertising exchange of the present invention provides a forum and source for new advertising media and revenue sources for governmental authorities, utilities and private industry. By bringing together advertisers with the suppliers of tangible advertising media, the advert sizing exchanger generates new business and increases revenue for single use product manufacturers participating in the new advertising medium. It also generates new business for the advertising industry and the product marketing industry. It creates new employment for product participating companies, printers, graphic industry, advertising and marketing industries. The advertising exchange creates new interest in the advertising and marketing industries. The advertising exchange also introduces new advertisement avenues for charities to solicit contributions.

### BRIEF DESCRIPTION OF THE DRAWINGS

The present invention can best be understood in connection with the accompanying drawings in which:

FIG. 1 is a perspective view of an advertisement applied to a surface of a roadside barrier;

FIG. 2 is a perspective view of an advertisement applied to a surface of a road divider module;

FIG. 3 is a front elevation view of an advertisement applied to a panel of a multi-panel highway noise abatement wall;

FIG. 4 is a perspective view of various advertisements applied to a highway bridge parapet wall, support structures thereof and for support columns thereof;

FIG. 5 is a perspective view of an advertisement applied to the exterior cylindrical wall of a municipal waste tower;

FIG. 6 is a perspective view of various advertisements applied to U.S. Postal Service® products, including on reverse back sides of mailing envelopes, auxiliary exterior walls of parcel post packages, and upon non-logo bearing walls of mail collection boxes;

FIG. 7 is a front elevation view of a U.S. Postal Service® postage stamp bearing an advertisement applied thereto;

FIG. 8 is a perspective view of a packaging carton/box showing various advertisements on an inside surface of a lid thereof, and upon interior and exterior secondary walls of a product enclosure container portion thereof;

FIG. 9 is a perspective view of a removable transparent protective plastic cover bearing an advertisement thereon, showing the protective plastic cover being removed from a product container;

FIG. 10 is a perspective view of an unraveled portion of a rolled gift wrap paper roll, showing an advertisement applied to a reverse side thereof;

FIG. 11 is a perspective view of an unraveled paper towel roll of a plurality of detachable paper towels with perforated edges, showing respective discrete advertisements applied to individual paper towels;

FIG. 12 is a perspective view of a pile of paper or other material napkins, each bearing a respective advertisement applied thereto;

FIG. 13 is a perspective view of respective advertisements applied to various surfaces of disposable drinking cups and lids; and

FIG. 14 is a perspective view of a paper or plastic grocery/sundry bag containing an advertisement applied thereto.

FIG. 15 is a block diagram of an embodiment for an advertising exchange coordinating available unused surface owners with advertisers seeking locations for display of advertising.

FIG. 16 is a block diagram of an alternative embodiment for an advertising exchange to that shown in FIG. 15.

FIG. 17 is a flow chart showing the computer controls of the method disclosed in FIGS. 14 and 15.

The aforementioned drawing Figures all illustrative of best modes thereof; and it is known that other embodiments may be implied from the description thereof.

### DETAILED DESCRIPTION OF THE EMBODIMENTS

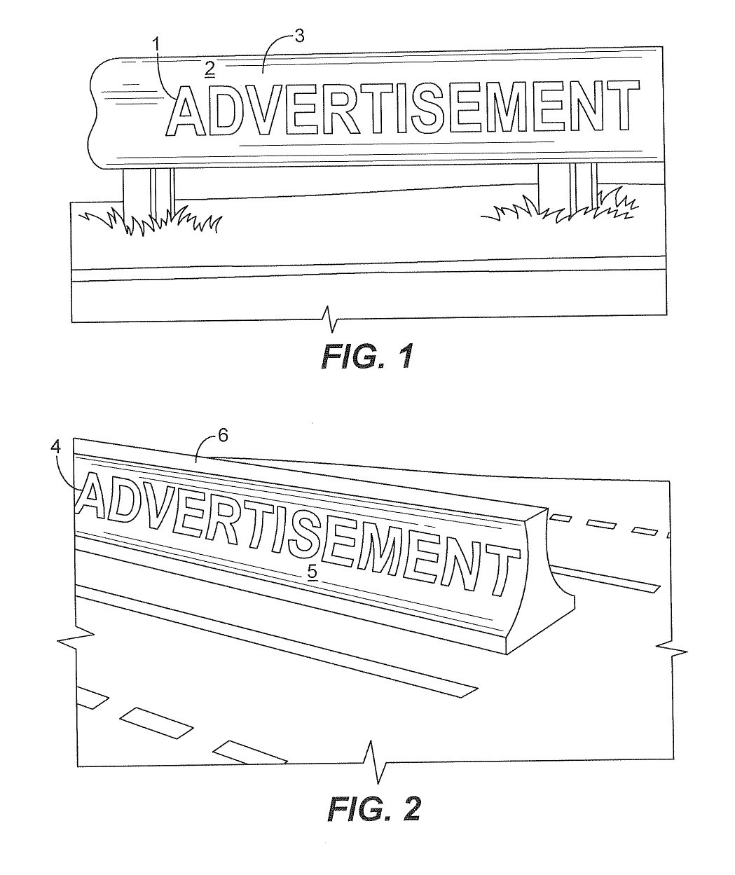

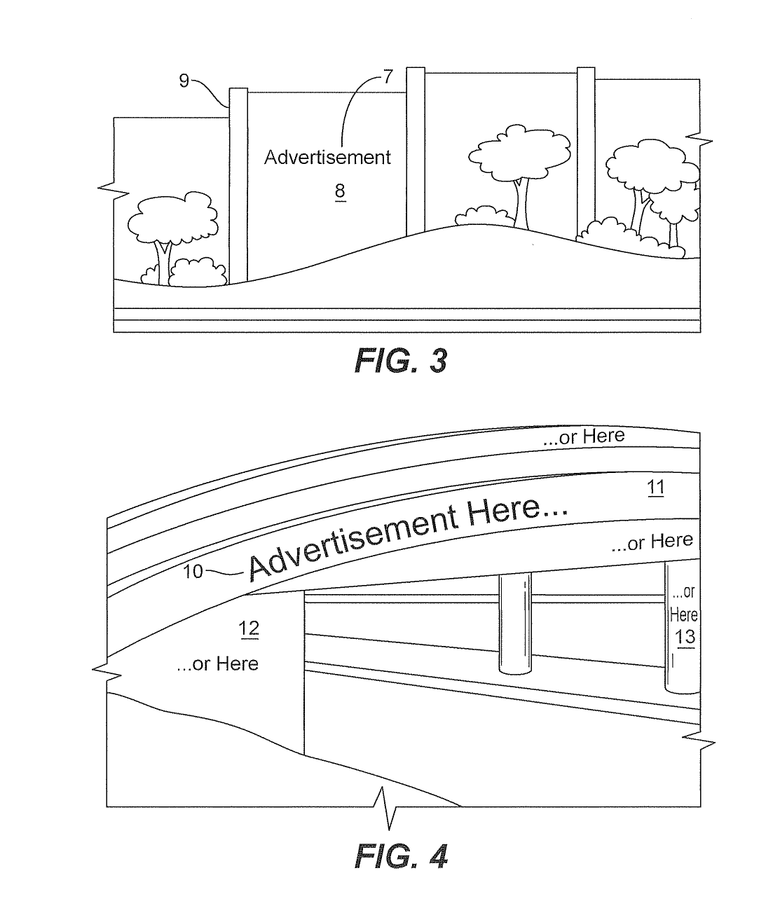

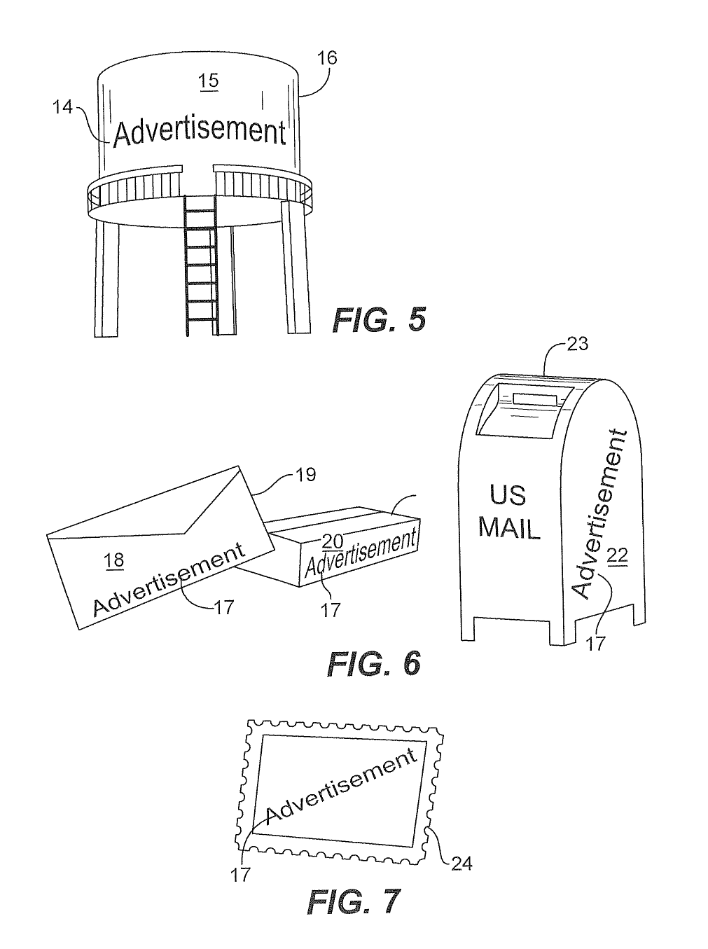

The present invention develops sources for those wishing to target the end users who they believe use the products. In a first embodiment, FIGS. 1-5 show advertisements on previously unused surfaces of municipal structures. For example, FIG. 1 shows an advertisement 1 applied to a surface 2 of a roadside barrier 3. FIG. 2 shows an advertisement 4 applied to a surface 5 of a road divider module 6. FIG. 3 shows an advertisement 7 applied to a panel 8 of a multi-panel highway noise abatement wall 9. FIG. 4 depicts various advertisements 10 applied to a highway bridge parapet wall 11, support structures 12 thereof and for support columns 13 thereof. FIG. 5 shows an advertisement 14 applied to the exterior cylindrical wall 15 of a municipal waste tower 16.

In an alternate embodiment, FIG. 6 shows various advertisements 17 applied to U.S. Postal Service® products, including on reverse back sides 18 of mailing envelopes 19, auxiliary exterior walls 20 of parcel post packages 21, and upon non-logo bearing walls 22 of mail collection boxes 23. For example, FIG. 7 shows a typical U.S. Postal Service® postage stamp 24 bearing an advertisement 17 applied thereto.

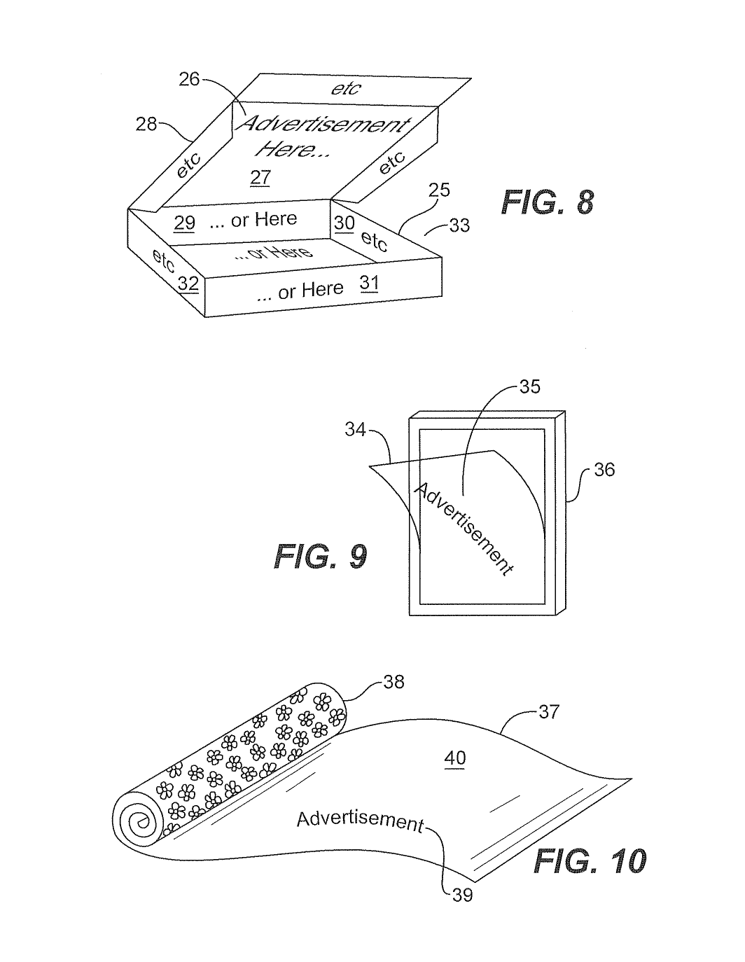

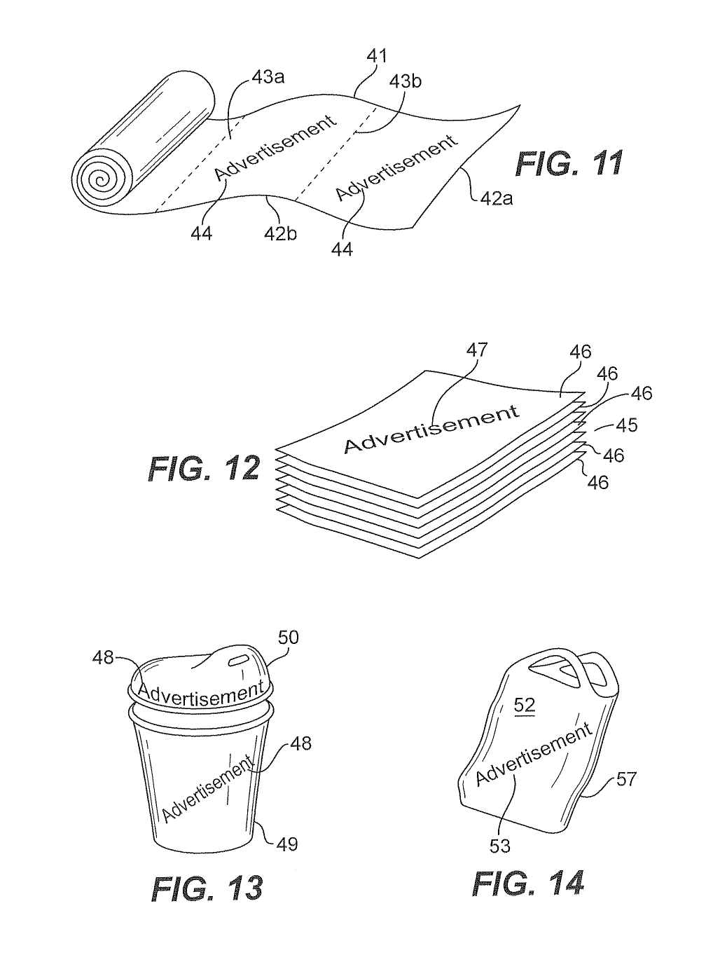

FIGS. 8-14 show the use of advertising on unused surfaces of paper and plastic container and other substrate products. For example, FIG. 8 shows a packaging carton/box 25 showing various advertisements 26 on an inside surface 27 of a packaging lid 28 thereof, and upon interior and exterior secondary walls 29, 30, 31, 32 of a product enclosure container 33 portion thereof;. Likewise, FIG. 9 depicts a removable transparent protective plastic cover 34 bearing an advertisement 35 thereon, showing the protective plastic cover 34 being removed from a product container 36 . FIG. 10 shows an unraveled portion 37 of a rolled gift wrap paper roll 38, showing an advertisement 39 applied to a reverse side 40 thereof. Concerning disposable paper substrate products, they may be adorned with advertisements. For example, FIG. 11 shows an unraveled paper towel roll 41 of a plurality of detachable paper towels 42a, 42b, etc., with perforated edges 43a, 43b, showing respective discrete advertisements 44 applied to individual paper towels 42a, 42b. FIG. 12 shows a pile 45 of paper or other material napkins 46, each bearing a respective advertisement 47 applied thereto. Furthermore, FIG. 13 depicts respective advertisements 48 applied to various surfaces of disposable drinking cups 49 and lids 50, and FIG. 14 shows a paper or plastic grocery/sundry bag 51 with a display surface 52 containing an advertisement 53 applied thereto.

Moreover, this invention relates to the expansion of print advertising incorporating stationary images and text as applied to products or structures which exist to serve a primary function. The novel aspects involve not only the examples shown in FIGS. 1-14 on which a variety of advertisements are emblazoned on a wide variety of improbable objects and structures, but also on an advertising exchange to facilitate this mode of advertising. Since physical print advertising as a medium has not evolved dramatically to venues such as internet on-line ads or elaborate electronic billboards with full motion capability, the outlets have been largely limited to plain freestanding billboards, newspaper ads, and magazine advertising. This invention injects some welcome innovation to this ad segment by retaining the medium but greatly expanding the choice of venues.

As exemplified by FIGS. 1-14, many venues can be developed for ad use. Before an advertising exchange for secondary advertising can be automated, the various techniques of creating the physical technology that is compatible with each venue at a cost-effective level must be perfected. The pioneering advertisers will necessarily be clients of established ad agencies or of new entities exclusively introducing these secondary advertising campaigns. Estimates of “number of views” for each venue must be based on analysis initially, and then verified by field testing. A database of statistics and success stories must be assembled. Cost spreadsheets will also evolve. The start-up will be manual until the medium itself is more commonplace. Articles in advertising publications and business journals will further create “the pull” from advertisers. Once the start-up phase is up and running, conversion to an advertising exchange operation is feasible.

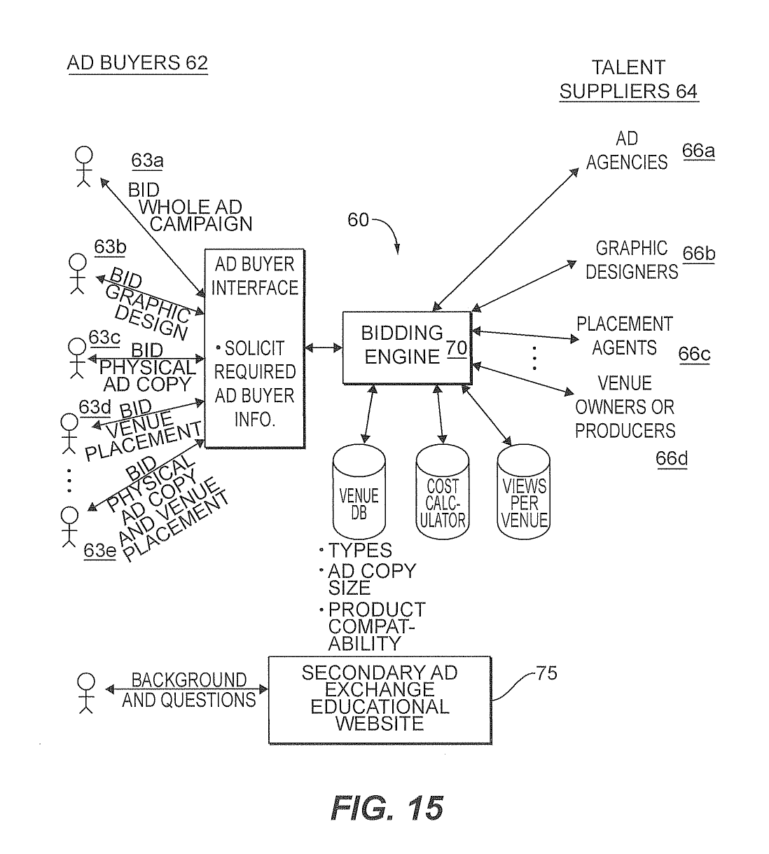

FIG. 15 illustrates one possible high level block diagram of activity of an automated advertising exchange 60 that runs on-line. The activity is competitive in terms of advertisers (ad buyers) 62 bidding on various portions 63a, 63b, 63c, 63d and 63e, etc., of the work such as required to create graphic design and message, select the venue, create the physical ads, and contract to place the ads. Talent suppliers 64 interact with ad buyers through bidding engines 70 either for portions of the job or for turnkey ad campaigns. Initially, the point of contact for ad buyers can be ad agencies 66a with the rest of the interaction and on-line bidding restricted to subcontractors 66b, 66c, 66d, etc., dealing with the agencies 66a of talent suppliers 64. Agencies 66a can be streamlined by virtue of not having all activities in-house; in fact they could bid on subcontracted tasks. Any advertising exchange 60 for secondary advertising will be supported by an educational website 75 where ad buyers 62 are exposed to the wide variety of venues available along with case studies, cost ranges, and any potential exposures such as statutory restrictions prohibiting some activities. A key aspect would be the compatibility of product to revenue.

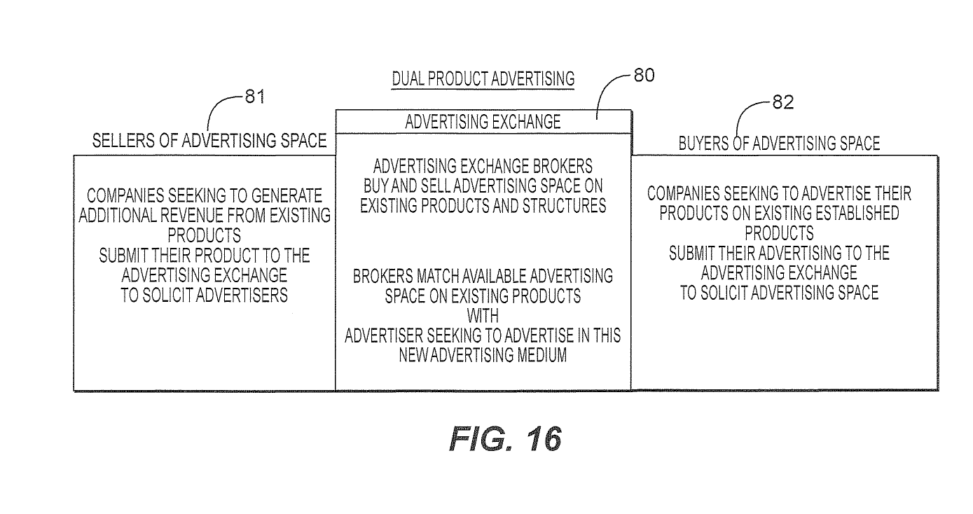

The simplified process described by the block diagram of FIG. 16 is an alternative to that shown in FIG. 15. Although it can be run manually with the help of phones and E-mails, it can also be automated and run completely on-line using artificial intelligence techniques to substitute for the possibly “human brokers” mentioned in the Advertising Exchange. Note that no “bidding” is involved in the activity of FIG. 16. Simply described, the Advertising Exchange 80 is a match-maker between sellers 81 of advertising space and buyers 82 of advertising space. The sellers of advertising space would be any of the property owners or product manufacturers as described in FIGS. 1-14. The buyers 82 of advertising space already have their graphic design and message in hand for secondary advertising (as either internally generated or supplied by an ad agency that is not part of this diagram).

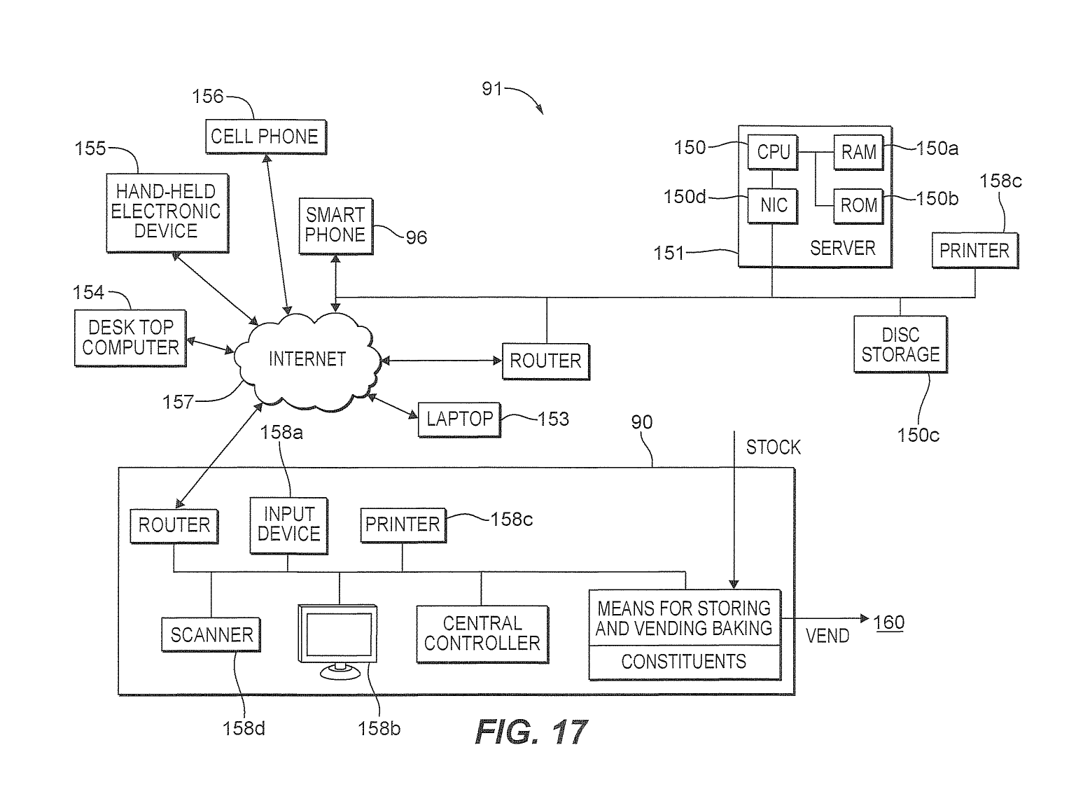

As shown in FIG. 17, an advertising exchange has a computer-based system 91 associated with company website and the Internet, by which the inventive method or application program disclosed in FIGS. 15 and 16 can be implemented by the advertising exchange and be carried out. The advertising exchange operates a computer controlled advertising coordination exchange entity 90 with the computer-based system 91, which, as shown in FIG. 17, includes a central processing unit 150, which houses a processor, and other systems components (not shown expressly in the drawing figure) that implement a general purpose processing system, or computer that may execute a computer program product. The advertising exchange operates according to the methods of FIGS. 15 and 16, until ready for brokering an agreement between a surface space supplier and an advertiser at step 160 of the process of FIG. 17 The central processing unit 150 includes both Random Access Memory (RAM) 150a and Read Only Memory (ROM) 150b and other software through a server 151. The computer program product 91 may comprise media, for example a compact storage medium such as a compact disc in the advertising exchange entity 90 with an input device 158a, such as shown in FIG. 17, for example, a touch screen 92, keyboard input, mouse or voice activated input 158a and visual and/or audio/visual display 158b or it may comprise wireless media from the Internet 157 communicating with a server 151 communicating with the advertising exchange's central Processing unit 150 of their computer systems 91, wherein the media readable by an exchange employee having a handheld personal electronic device, such as a smart phone 96, laptop, desk top computer 154, handheld electronic device 155 (such as a tablet pad) or cell phone 156, each having Internet access and an installed application (i.e. “App”), which may be read by the processing unit 150 through a disc drive or network interface card 150d, or by any means known to the skilled artisan for providing the computer program product to the general purpose processing system for use in the computer system for the advertising exchange entity 90 thereby. For example, the network interface card 150d connects computer/server 151 to a network bus.

The computer program product comprises all the respective features enabling the implementation of the inventive method for the advertising exchange described herein, and which—when loaded in a computer system 91 of the advertising exchange entity 90 communicating directly or remotely with the advertising exchange's computer 91 through website 95 over the Internet 157—is able to carry out the computer system 91 for the desired implementation of the advertising exchange.

It is further noted that “computer program”, “software program”, “program”, or “software”, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product 91 of the advertising exchange entity 90 for the advertising exchange, through its website 95, may be stored on hard disk drives within processing unit 150, as mentioned, or may be located on a remote system such as a server 151 communicating through the Internet 157 with other remote processing units such as advertising exchange shop 90 or Internet-capable user operable devices, such as portable electronic devices 96, 153, 154, 155 and/or 156 of shop employees. These may include, among other devices known to those skilled in the computer arts, devices, such as smart phones 96, laptops 153, computers 154, other handheld electronic devices 155, such as a tablet pads, or cell phones 156 coupled to processing unit 150 of computer 91, via a network interface of the Internet 157 such as an Ethernet interface or other compatible device. The input 158a, such as a keyboard or touch screen 94 or voice activated system, mouse and/or keyboard are either coupled to the processing unit 150 of the advertising exchange's computer system 91, or via the Internet 157 through server 151, to provide user interaction for the computer system for the advertising exchange. A display monitor of input 158a may also be used with a large screen or remote screen on the advertiser's or vendor's Internet enabled devices for display of possible locations for advertising. during use of the computer system processes noted as reference numeral 160 An output device 93, such as a printer 158c and scanner 158d are provided for document input and output associated with the advertising exchange, Display 93, such as printer 158c, is shown communicating with the Internet 157, or directly to a network connection communicating directly with the advertising exchange's central processing unit 150 via the advertising exchange's website 95, but may be coupled directly to the processing unit 150 of computer 91 of the advertising exchange's advertising exchange shop 90. Scanner 158d is shown but it should be understood that peripherals might be network coupled, or direct coupled without affecting the ability of the processing unit 150 to perform the computer 91 system's functions for the advertising exchange process of the invention.

The present invention is not limited to the content of this application but includes any and all similar ideas, applications, products not specifically mentioned in the text of the present invention.

We claim:

1. A method for facilitating visual commercial advertising brokerage comprising the steps of
a. using a computer having digital data processing means, digital data storage means, digital data input means, digital data output means and digital data display means;
b. inputting into said computer digital storage means digital data regarding advertising venues, said digital venue data submitted by providers of visual advertising display space comprising availability, respectively, of a plurality of advertising venues which further comprise visual advertising display space opportunities;
c. inputting into said computer digital storage means digital data comprising a plurality of bid requests for said advertising venues comprising available visual commercial advertising space submitted by bid requestors who are potential advertisers seeking to engage at least one of said venues advertising display space opportunities to advertise goods or services;
d. concurrently withdrawing said digital data from said digital computer storage means and feeding it to said computer digital processing means;
e. digitally matching within said computer digital processing means said input digital data comprising said plurality of available-venue visual advertising display space opportunities with said plurality of bid requests for said venues comprising visual commercial advertising space;
f. digitally outputting the result of said matching of digital venue visual commercial advertising display space availability data with said commercial advertising visual display space bid request digital data so as to comprise a digitally-displayable and digitally storable resulting body of digital data comprising
(a) a plurality of commercial advertising visual display space bid requests for formatting and appropriate graphic display presentation to said providers of visual advertising display space as well as;
(b) a plurality of commercial advertising venue visual display space availabilities for formatting and appropriate graphic display presentation to said potential advertiser bid requestors who have submitted said bid requests for said available visual commercial advertising space.

2. The method of computer advertising brokerage of claim 1, wherein further,
a. said computer comprises at least one discrete digital data storage means for inputting and storing digital data relating to advertising buyers who are or who may become bid requestors for
(a) entire advertising campaigns;
(b) graphic design services;
(c) physical advertising copy providers;
(d) venue placement providers;
(e) combined providers of physical advertising copy and venue placement;
b. wherein further, said computer comprises at least one discrete digital data storage means for inputting and storing digital data relating to advertising venues, further comprising digital information regarding said advertising venues' respective
(a) advertising types;
(b) advertising copy size;
(c) advertising product compatibility
c. wherein further, said computer comprises at least one discrete digital data storage means for inputting and storing digital data relating to calculation of costs for said plurality of respective advertising venues;
d. wherein further, said computer comprises at least one discrete digital data storage means for inputting and storing digital data relating to views per venue;
e. wherein further, said computer comprises at least one discrete digital data storage means for inputting and storing digital data relating to advertising agency contact information;
f. wherein ftirther, said computer comprises at least one discrete digital data storage means for inputting and storing digital data relating to talent provider contact information;
g. wherein further, said computer comprises at least one discrete digital data storage means for inputting and storing digital data relating to graphic designer contact information;
h. wherein further, said computer comprises at least one discrete digital data storage means for inputting and storing digital data relating to advertising placement agent contact information;
i. wherein further, said computer comprises at least one discrete digital data storage means for inputting and storing digital data relating to advertising venue owner contact information; and
j. wherein further, said computer comprises at least one discrete digital data storage means for inputting and storing digital data relating to advertising venue producers; and further wherein
k. said computer comprises at least one discrete digital data processing means comprising at least one proprietary algorithm for accepting and processing and outputting a digital data result product that comprises a brokerage exchange displayable and communicable data product that results from manipulation by said at least one algorithm of said digital data from at least one of said stored data types comprising
(a) said entire advertising campaign bid requests;
(b) said graphic design bid requests;
(c) said physical advertising copy bid requests;
(d) said advertising venue placement bid requests;
(e) said combined physical advertising copy bid requests and said advertising venue placement bid requests;
(f) said digital data relating to advertising venues, further comprising digital information regarding said advertising venues' respective advertising types; said advertising venues' respective advertising copy size; said advertising venues' respective advertising product compatibility;
(g) data relating to calculation of costs for said plurality of respective advertising venues;
(h) data relating to calculation of views per venue
(i) data relating to talent supplier contact information;
(j) data relating to advertising agency contact information;
(k) data relating to graphic designer contact information;
(l) data relating to advertising placement agent contact information;
(m) data relating to advertising venue owner contact information; and
(n) data relating to advertising venue producer contact information;

3. The method of computer advertising brokerage of claim 2, wherein further,
said computer at least one discrete digital data processing means comprising at least one proprietary algorithm (first set forth in claim 2k, above) further comprises a bidding engine.

4. The method of computer advertising brokerage of claim 2, wherein further,
said digital data result product (originally set forth at claim 2k above) that comprises a brokerage exchange displayable and communicable data product further comprises at least one offer to at least one bid requestor for the purchase of advertising space; and wherein
said digital data result product (originally set forth at claim 2k above) that comprises a brokerage exchange displayable and communicable data product further comprises at least one bid to at least one advertising venue provider for the purchase of advertising space.

5. The method of computer advertising brokerage of claim 2, wherein further,
said computer comprising at least one discrete digital data processing means comprising at least one proprietary algorithm wherein said algorithm incorporates a series of data manipulations comprising an auction-style bidding scheme capable of awarding offers to advertising bid requestors in order of largest to smallest bid request.
